(19) United States
(12) Patent Application Publication
(10) Pub. No.: US 2012/0249584 A1
(43) Pub. Date: Oct. 4, 2012

(54) IMAGE PROCESSING APPARATUS, IMAGE PROCESSING METHOD, AND RECORDING MEDIUM

(75) Inventor: Kenichi NARUSE, Tokyo (JP)

(73) Assignee: CASIO COMPUTER CO., LTD., Tokyo (JP)

(21) Appl. No.: 13/435,624

(22) Filed: Mar. 30, 2012

(30) Foreign Application Priority Data
Mar. 31, 2011 (JP) 2011-077381

(51) Int. Cl. G06K 9/36; G09G 5/00

(52) U.S. Cl. 345/629; 382/284

(57) ABSTRACT

An image processing apparatus, includes: a first acquisition unit to acquire a first image; a second acquisition unit to acquire a second image obtained by performing predetermined image processing for the first image; a compositing unit to generate a composite image composed of the first and second images that are combined to be superimposed on each other; a specifying unit to specify, based on a user's predetermined operation of an operation input unit, a change region in the composite image whose composition ratio is to be changed; and a controller to change transparency of the upper one of the first and second images to change the composition ratio at which the compositing unit combines the first and second images in the change region specified by the specifying unit.

### BACKGROUND OF THE INVENTION

1. Field of the Invention

The present invention relates to an image processing apparatus, an image processing method, and a recording medium.

2. Description of Related Art

Conventionally-known image processing apparatuses perform image processing such as sharpening for image data with a processing degree specified by a user (Japanese Patent Laid-open Publication No. 2001-167265 (PTL 1)).

However, in the case of the aforementioned PTL 1 or the like, each time the processing degree of the image processing is changed, image processing needs to be performed with a new processing degree. It is therefore difficult for an image processing apparatus including an arithmetic unit not having high processing capacity to perform processing at higher speed. Particularly in the case of repeatedly fine-tuning the processing degree of the image processing or changing the processing degree for only a part of the image, it takes a lot of time to provide a processed image having an appearance (processing degree) desired by a user.

### SUMMARY OF THE INVENTION

The present invention was made in the light of the above described problem, and an object of the present invention is to provide an image processing apparatus, an image processing method, and a recording medium which can shorten processing time that it takes to change the output style of only a predetermined region of a processing object image.

According to an embodiment of the present invention, there is provided an image processing apparatus, including: a first acquisition unit to acquire a first image; a second acquisition unit to acquire a second image obtained by performing predetermined image processing for the first image; a compositing unit to generate a composite image composed of the first and second images that are combined to be superimposed on each other; a specifying unit to specify, based on a user's predetermined operation of an operation input unit, a change region in the composite image whose composition ratio is to be changed; and a controller to change transparency of the upper one of the first and second images to change the composition ratio at which the compositing unit combines the first and second images in the change region specified by the specifying unit.

According to an embodiment of the present invention, there is provided an image processing method, including the steps of: acquiring a first image; acquiring a second image obtained by performing image processing for the first image; generating a composite image composed of the first and second images that are combined to be superimposed on each other; specifying a change region in the composite image whose composition ratio is to be changed based on a user's predetermined operation of an operation input unit; and changing transparency of the upper one of the first and second images to change the specified composition ratio of the first image to second image in the specified change region.

According to an embodiment of the present invention, there is provided a recording medium recording a program for causing a computer of an image processing apparatus to function as: a first acquisition unit to acquire a first image; a second acquisition unit to acquire a second image obtained by performing predetermined image processing for the first image; a compositing unit to generate a composite image composed of the first and second images that are combined to be superimposed on each other; a specifying unit to specify, based on a user's predetermined operation of an operation input unit, a change region in the composite image whose composition ratio is to be changed; and a controller to change transparency of the upper one of the first and second images to change the composition ratio at which the compositing unit combines the first and second images in the change region specified by the specifying unit.

### BRIEF DESCRIPTION OF THE DRAWINGS

FIG. 1 is a block diagram showing a schematic configuration of an image output apparatus of an embodiment to which the present invention is applied.

FIG. 2 is a flowchart showing an example of an operation concerning an image generation process by the image output apparatus of FIG. 1.

FIGS. 3A and 3B are views for explaining the image generation process of FIG. 2.

FIGS. 4A and 4B are views for explaining the image generation process of FIG. 2.

FIGS. 5A and 5B are views for explaining the image generation process of FIG. 2.

### DESCRIPTION OF THE PREFERRED EMBODIMENTS

Hereinafter, a description is given of a specific mode of the present invention using drawings. However, the scope of the invention is not limited to the examples shown in the drawings.

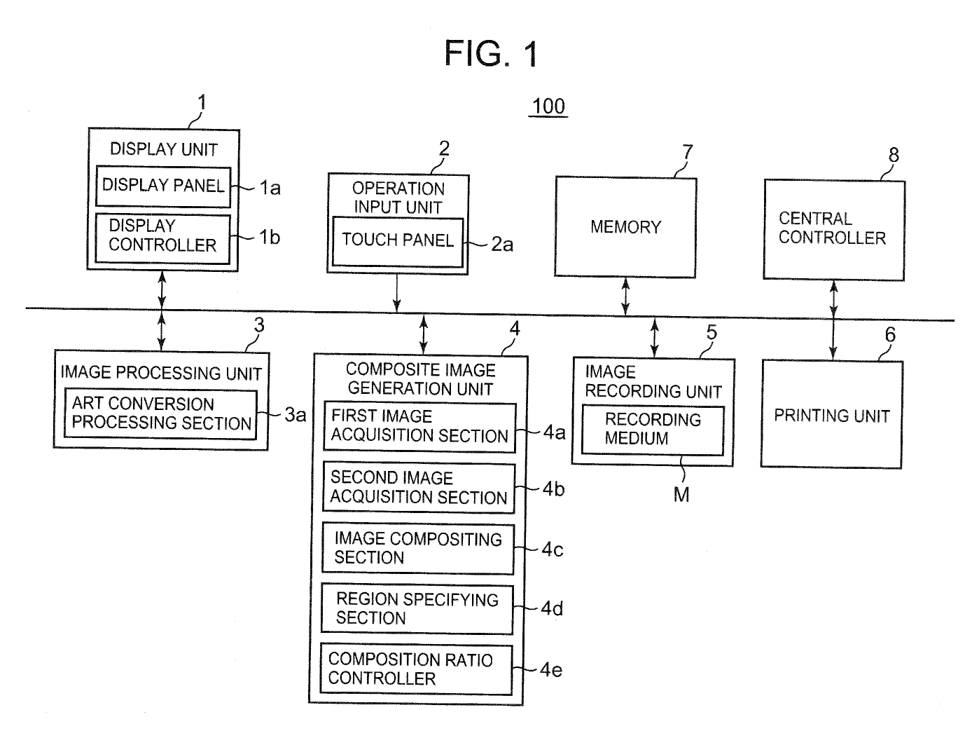

FIG. 1 is a block diagram showing a schematic configuration of an image output apparatus 100 of an embodiment to which the present invention is applied.

The image output apparatus 100 of this embodiment combines a first image P1 and a second image P2 to generate a composite image P3 and changes a composition ratio of the first image P1 to second image P2 in a predetermined region A of the composite image P3 specified based on a user's predetermined operation of an operation input unit 2.

Specifically, as shown in FIG. 1, the image output apparatus 100 includes a display unit 1, the operation input unit 2, an image processing unit 3, a composite image generation unit 4, an image recording unit 5, a printing unit 6, a memory 7, and a central controller 8.

The display unit 1 includes a display panel 1a and a display controller 1b.

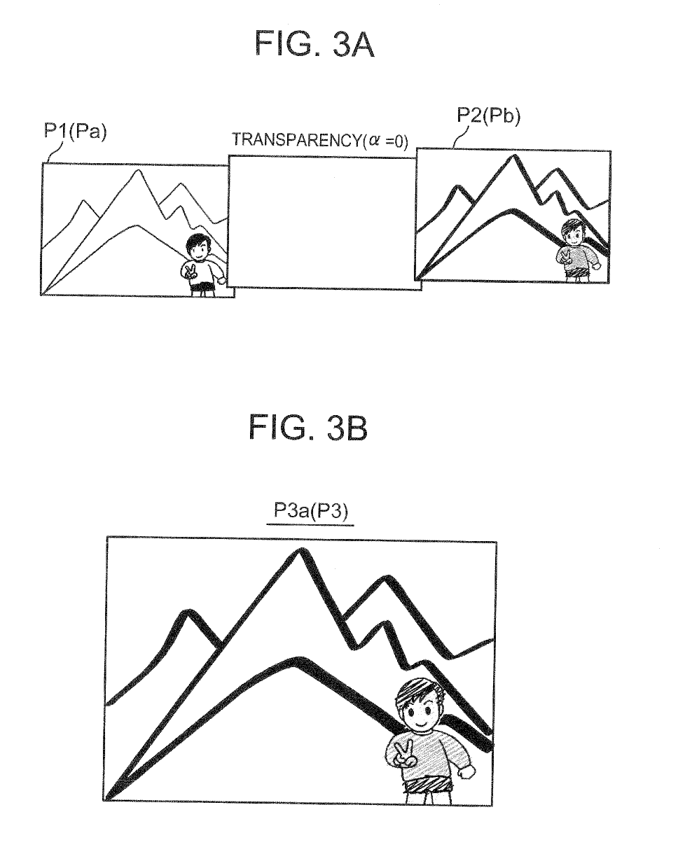

The display controller 1b causes a display screen of a display panel 1a to display image data of the composite image P3 (see a composite image P3a in FIGS. 3A and 3B, for example) generated by the composite image generation unit 4 or image data which is read from a recording medium M of the image recording unit 5 and is decoded by the image processing unit 3.

The display panel 1a is composed of a liquid crystal display panel, an organic EL display panel, or the like, for example, but is not limited to those examples.

The operation input unit 2 includes operating portions composed of data input keys for entering numerals, characters, and the like, up, down, right, and left keys for data selection, feeding operation, and the like, various function keys, and the like. The operation input unit 2 outputs a predetermined operation signal according to an operation of the operating portions.

The operation input unit 2 includes a touch panel 2a integrally provided for the display panel 1a of the display unit 1.

The touch panel 2a detects the position of a user's finger (hand), a touch pen, or the like which is in direct or indirect contact with the display screen constituting an image display region of the display panel 1a (hereinafter, referred to as a touch position). Specifically, the touch panel 2a is provided on or inside the display screen and is configured to detect XY coordinates of the touch position on the display screen by various methods including a resistive film method, an ultrasonic surface acoustic wave method, and a capacitive method. The touch panel 2a is configured to output a position signal concerning the XY coordinates of the touch position.

The precision of detecting the touch position on the display screen by the touch panel 2a can be properly and arbitrarily changed. For example, the touch position may include only one pixel precisely or may include plural pixels within a predetermined range around the one pixel.

The image processing unit 3 includes an art conversion section 3a.

The art conversion section 3a is configured to perform art conversion which processes a predetermined image Pa as a processing object into an image having various types of visual effects.

Herein, the art conversion refers to image processing to change the visual effect of the predetermined image Pa as a processing object, that is, to change the display style of the image Pa which is being displayed on the display unit 1. To be specific, examples of the art conversion are “color pencil effect conversion” to obtain an image including a visual effect as if the image is drawn by color pencils (see FIG. 3A), “oil painting effect conversion” to obtain an image including a visual effect as if the image is drawn by oil paints, and “water color effect conversion” as if the image is drawn by watercolors. However, these are just examples, and the art conversion is not limited to these types of conversion and can be properly and arbitrarily changed.

The art conversion section 3a performs art conversion including a predetermined type of processing specified based on a user's predetermined operation of the operation input unit 2 (the color pencil effect conversion, for example) for the predetermined image Pa.

The technique to process an image into an image including various types of visual effects is implemented by a process substantially similar to the processes using software concerning publicly-known image processing, for example. The image processing is performed by changing the hue, saturation, and value in a HSV color space or using various types of filter. Such a technique is publicly known, so detailed description thereof is omitted. The “xx effect” refers to a visual effect obtained by art conversion which can be implemented by the software concerning the publicly-known image processing.

The image processing is not limited to the art conversion processing the predetermined image Pa to a painting-like image. The image processing can be properly and arbitrarily changed to contour enhancement, gray level correction, binarization, or the like.

Moreover, the image processing unit 3 may include an encoder which compresses and encodes image data according to a predetermined coding system (JPEG, for example), a decoder which decodes encoded image data recorded in a recording medium M with a decoding system corresponding to the predetermined coding system, and the like. Herein, the encoder and decoder are not shown in the drawings.

The composite image generation unit 4 includes a first image acquisition section 4a, a second image acquisition section 4b, an image compositing section 4c, and a region specifying section 4d, and a composition ratio controller 4e.

The first image acquisition section 4a is configured to acquire the first image P1.

Specifically, the first image acquisition section 4a acquires the first image P1 which is an image for composition by the image compositing section 4c. To be specific, the first image acquisition section 4a acquires image data of a predetermined image Pa which is read from the recording medium M and is decoded by the image processing unit 3 as the first image P1.

The first image acquisition section 4a may acquire one processed image (not shown) which is obtained by performing a predetermined type of image processing (the oil painting effect art conversion, for example) for image data of the predetermined image Pa by the image processing unit 3 as the first image P1.

The second image acquisition section 4b is configured to acquire a second image P2.

Specifically, the second image acquisition section 4b acquires the second image P2 as an image for composition by the image compositing section 4c. To be specific, the second image acquisition section 4b acquires, as the second image P2, image data of a processed image Pb which is obtained by performing a predetermined type of art conversion (color pencil effect art conversion, for example) for the image data of the predetermined image Pa acquired as the first image P1 by the art conversion section 3a of the image processing unit 3.

If one processed image (not shown) is acquired as the first image P1 by the first image acquisition section 4a, the second image acquisition section 4b may acquire, as the second image P2, another processed image (not shown) which is obtained by performing a different predetermined type of art conversion from the type of art conversion (image processing) performed for the one processed image (the first image P1).

The image compositing section 4c is configured to combine the first and second images P1 and P2 to generate the composite image P3.

Specifically, the image compositing section 4c combines the image data of the predetermined image Pa acquired by the first image acquisition section 4a as the first image P1 and the image data of the processed image Pb which is already subjected to the predetermined type of art conversion and is acquired by the second image acquisition section 4b as the second image P2. To be specific, the image compositing section 4c generates the composite image P3 so that pixels of the image data of the predetermined image Pa as the first image P1 are laid on the corresponding pixels of the image data of the processed image Pb as the second image P2. For example, the image compositing section 4c superimposes the image data of the predetermined image P1 placed on the lower side in the vertical direction and the image data of the processed image Pb placed on the upper side one on the other to generate the composite image P3 (the composite image P3a, for example; see FIG. 3B).

The vertical direction is a direction substantially orthogonal to the display screen (the image display region) of the display unit 1 on which the composite image P3 is displayed (a viewing direction). The upper side is the near side to a viewer, and the lower side is the far side.

The region specifying section 4d is configured to specify a predetermined region A of the composite image P3.

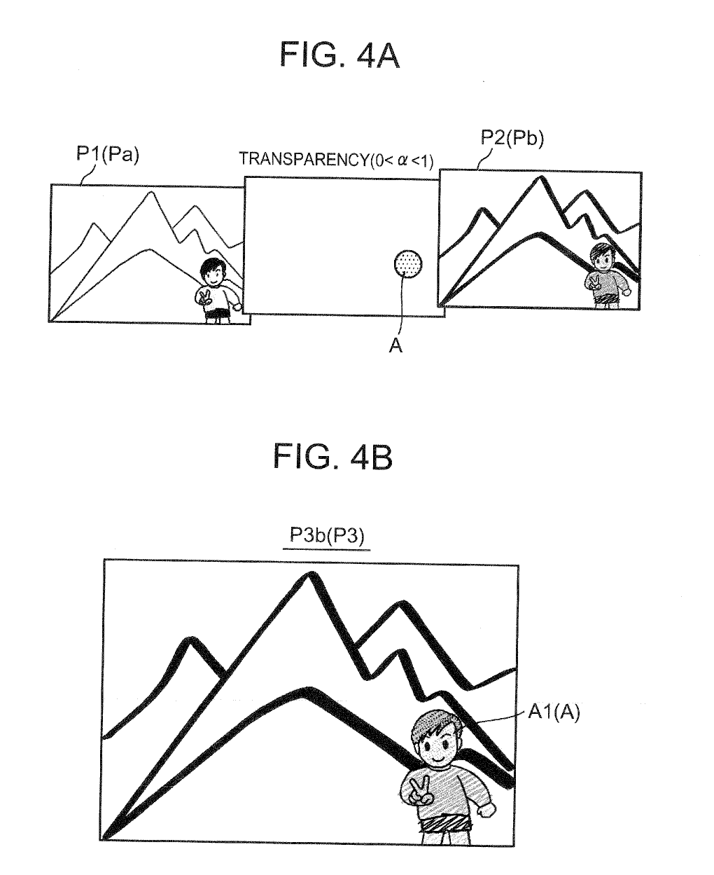

Specifically, the region specifying section 4d specifies the predetermined region A of the composite image P3 (see FIG. 4A) based on a user's predetermined operation of the operation input unit 2. To be specific, the region specifying section 4d specifies the predetermined region A of the composite image P3 based on the touch position detected by the touch panel 2a according to a user's touch operation of the touch panel 2a of the operation input unit 2. For example, if the touch position is detected according to the user's predetermined touch operation of the touch panel 2a in the state where the composite image P3 is displayed on the display panel 1a of the display unit 1, the operation input unit 2 outputs a position signal concerning the XY coordinates of the touch position to the region specifying section 4d. Upon receiving the position signal outputted from the operation input unit 2, the region specifying section 4d specifies the predetermined region A of the composite image P3 (a face region A1, for example) based on the received position signal.

Herein, the region specifying section 4d may specify the input state of the position signal concerning the user's touch position on the touch panel 2a which is outputted from the operation input portion 2 as the user's touch operation on the touch panel 2a. The input state includes the number of position signals inputted per unit time according to the number of times that the user touches the touch panel 2a per unit time, time for which the position signal continues to be inputted according to the time from the start to the end of the touch operation on the touch panel 2a, and the like.

The operation to specify the predetermined region A of the composite image P3 is performed by using the touch panel 2a, but this is just an example. The specifying operation is not limited to the above example and may be performed using another button of the operation input unit 2, for example, up, down, right, and left keys.

The composition ratio controller 4e is configured to change the composition ratio of the first image P1 to the second image P2.

The composition ratio controller 4e changes the composition ratio at which the image compositing section 4c combines the predetermined image Pa (the first image P1) and the processed image Pb (the second image P2) in the predetermined region A of the composite image P3 which is specified by the region specifying section 4d. To be specific, the composition ratio controller 4e changes the composition ratio by changing the transparency of the processed image Pb in the predetermined region A of the predetermined image Pa and processed image Pb superimposed one on the other. The transparency refers to the degree at which the processed image (the upper image) Pb allows the predetermined image (the lower image) Pa to be seen therethrough.

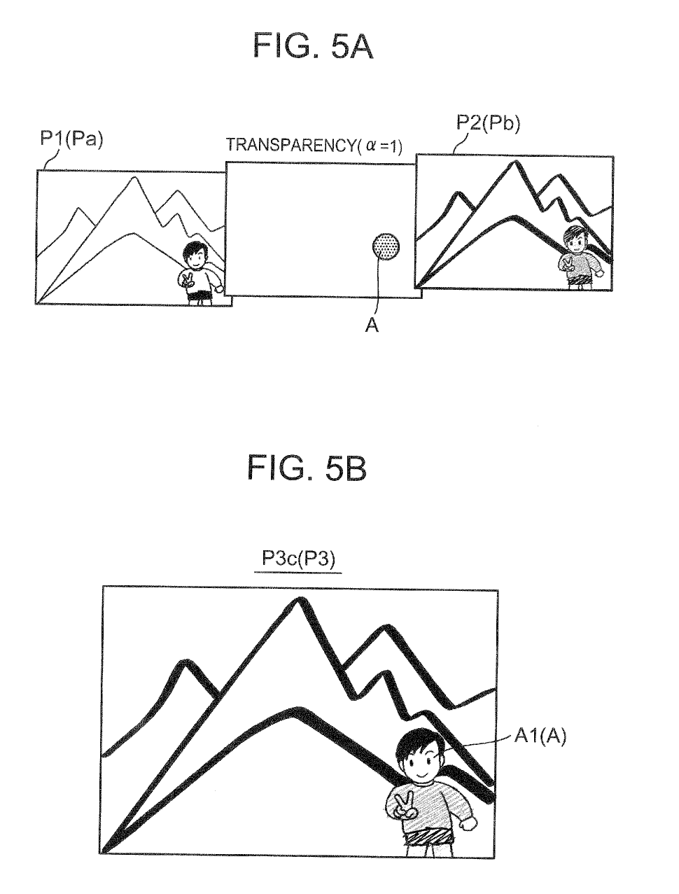

For example, the composition ratio controller 4e uses an alpha value (0<=α<=1) which is a weight used for alpha bending of the processed image Pb with the predetermined image Pa to change the composition ratio of the processed image Pb to the predetermined image Pa. To be specific, the composition ratio controller 4e specifies the position of the predetermined region A in the processed image Pb, which is the upper image of the composite image P3, and generates position information indicating the position of the predetermined region A in the composite image P3 (an alpha map, for example). The composition ratio controller 4e then determines the pixel value of each pixel of the predetermined region A in the following manner. If the alpha value of each pixel of the processed image Pb in the predetermined region A is 0 (see FIG. 3A), the transparency of the processed image Pb is equal to 0%, and each pixel of the predetermined region A is set to the pixel value of the corresponding pixel of the processed image Pb (see FIG. 3B). If the alpha value of each pixel of the processed image Pb in the predetermined region A is 1 (see FIG. 5A), the transparency of the processed image Pb is equal to 100%, and each pixel of the predetermined region A is set to the pixel value of the corresponding pixel of the predetermined image Pa (see FIG. 5B). If the alpha value of each pixel of the processed image Pb in the predetermined region A is 0<α<1 (see FIG. 4A), the transparency of the processed image Pb varies from 0 to 100%, and each pixel of the predetermined region A is set to a sum (blending) of a product of the pixel value of each pixel of the predetermined image Pa and the alpha value (transparency) and a product of the pixel value of the corresponding pixel of the processed image Pb and 1′s complement (1−α) (see FIG. 4B).

In FIGS. 4A and 5A, the transparency (α value) of the predetermined region A is schematically represented by the number of dots. A larger number of dots represent a higher transparency (α value).

Moreover, the composition ratio controller 4e may change the transparency of the processed image Pb in the predetermined region A based on the type of the detected touch operation when detecting the user's touch operation of a region on the display screen of the touch panel 2a where the predetermined region A of the composite image P3 is displayed. The composition ratio controller 4e may change the transparency based on the number of position signals inputted per unit time according to the number of times that the user touches the touch panel 2a per unit time or based on the time for which the user continues to perform the touch operation of the touch panel 2a. For example, the composition ratio controller 4e gradually increases or reduces the transparency of the processed image Pb in the predetermined region A of the composite image P3 according to an increase in the number of position signals inputted per unit time or the time for which the position signal continues to be inputted. Whether to increase or reduce the transparency may be set based on a user's predetermined operation of the operation input section 2.

The composition ratio controller 4e changes the transparency of the processed image Pb in the predetermined region A based on a touch operation (a sliding operation) that the user slidingly touches a predetermined part of the touch panel 2a (for example, a right or left edge portion) in a predetermined direction. For example, the composition ratio controller 4e gradually increases the transparency of the processed image Pb in the predetermined region A of the composite image P3 at a predetermined rate (for example, by 5%) according to the number of times of sliding operation that the user slidingly touches downward one of right and left edges of the touch panel 2a. On the other hand, the composition ratio controller 4e gradually reduces the transparency of the processed image Pb in the predetermined region A of the composite image P3 at a predetermined rate (for example, by 5%) according to the number of times of the sliding operation that the user slidingly touches upward one of right and left edges of the touch panel 2a.

The composition ratio is changed by changing the transparency of the second image P2 in the predetermined region A of the first and second images P1 and P2 superimposed one on the other. However, this method to change the composition ratio is just an example. The way of changing the composition ratio is not limited to this example and can be properly and arbitrarily changed.

The image recording unit 5 is configured to allow the recording medium M to be loaded in and unloaded from the same. The image recording unit 5 controls reading of data from the loaded recording medium M and writing of data in the recording medium M.

Specifically, the image recording unit 5 records, in the recording medium M, image data of the composite image P3 encoded with a predetermined compression method (JPEG, for example) by the encoder (not shown) of the image processing unit 3. To be specific, the recording medium M stores the image data of the composite image P3 in which the composition ratio of the first image P1 to the second image P2 combined by the image compositing section 4c is changed by the composition ratio controller 4e.

The recording medium M is composed of, for example, a non-volatile memory (flash memory) or the like, but is just an example. The recording medium M is not limited to this example and can be properly and arbitrarily changed.

The printing unit 6 generates a print of the composite image P3 based on image data of the composite image P3 generated by the composite image generation unit 4. To be specific, based on a predetermined print instruction operation by the user at the operation input unit 2, the printing unit 6 acquires image data of the composite image P3 from the memory 7 and prints the composite image P3 on a predetermined printing material by a predetermined printing method to generate a print of the composite image P3.

The printing material may be a sticker sheet or a normal sheet, for example. The predetermined printing method can be one of various publicly-known printing methods, and examples thereof are off-set printing, ink-jet printing, and the like.

The memory 7 includes a buffer memory temporarily storing image data of the first and second images P1 and P2 and the like, a working memory serving as a working area of the CPU of the central controller 8, a program memory storing various programs and data concerning the functions of the image output apparatus, and the like. These memories are not shown in the drawings.

The central controller 8 controls each section of the image output apparatus 100. To be specific, the central controller 8 includes the CPU (not shown) controlling each section of the image output apparatus 100 and performs various control operations according to various processing programs (not shown).

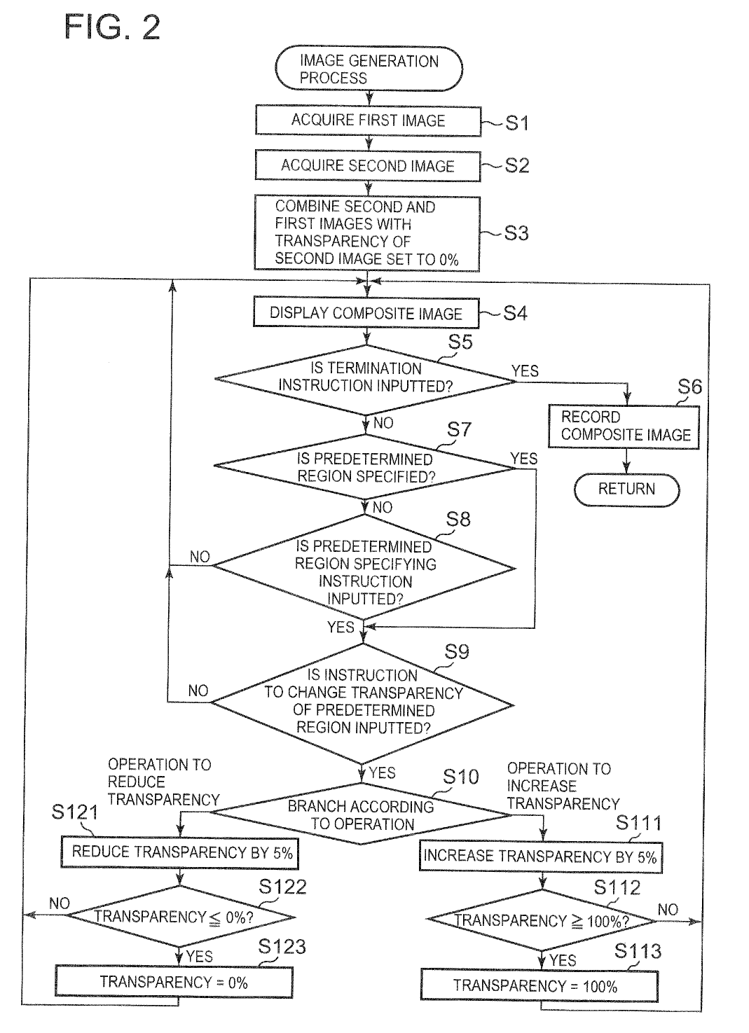

Next, a description is given of an image generation process by the image output apparatus 100 with reference to FIGS. 2 to 5B.

FIG. 2 is a flowchart showing an example of the operation concerning the image generation process.

The following image generation process is executed when a composite image generation mode is selected and specified among plural operation modes based on a user's predetermined operation of the up, down, right, and left keys, various function keys, or the like of the operation input portion 2.

In the following description, the first image P1 is the predetermined image Pa which is not subjected to predetermined image processing by the image processing unit 3, and the second image P2 is the processed image Pb which is subjected to predetermined art conversion (for example, color pencil effect conversion) by the image processing unit 3 (art conversion section 3a).

As shown in FIG. 2, at first, if the predetermined image Pa is specified among a predetermined number of images displayed on the display unit 1 based on a user's predetermined operation of the operation input unit 2, the first image acquisition section 4a of the composite image generation unit 4 acquires image data of the predetermined image Pa which is read from the recording medium M and decoded by the image processing unit 3 as the first image P1 (step S1). The composite image generation unit 4 then temporarily stores the image data of the predetermined image Pa acquired as the first image P1 in a predetermined storage area of the memory 7.

Subsequently, the art conversion unit 3a of the image processing unit 3 performs a predetermined type of art conversion (color pencil effect conversion, for example) for the predetermined image Pa acquired as the first image P1 to generate the processed image Pb. The second image acquisition unit 4b then acquires as the second image P2, image data of the processed image Pb generated (step S2). Subsequently, the composite image generation unit 4 temporarily stores the image data of the processed image Pb acquired as the second image P2 in a predetermined storage area of the memory 7.

The type of art conversion performed for the predetermined image Pa may be set based on a user's predetermined operation of the operation input unit 2 or may be set to a type previously determined by default.

Next, the composition ratio controller 4e of the composite image generation unit 4 sets the transparency of the processed image Pb as the second image P2 to 0%. The image synthetic section 4c then combines the image data of the predetermined image Pa (the first image P1) and the image data of the processed image Pb (the second image P2) to generate the composite image P3 (step S3).

To be specific, the image compositing section 4c places the image data of the first image P1 on the lower side and the image data of the second image P2 on the upper side to generate the composite image P3a (see FIG. 3B) so that pixels of the first image P1 are superimposed on the corresponding pixels of the second image P2. In this case, the alpha value of each pixel of the second image P2 is α=0 (see FIG. 3A), and each pixel of the composite image P3a has the same pixel value as the corresponding pixel of the second image P2 (the processed image Pb).

Thereafter, the display controller 1b acquires the image data of the composite image P3 (for example, the composite image P3a) generated by the composite image generation unit 4 and causes the display screen of the display panel 1a to display the same (step S4).

Subsequently, the CPU of the central controller 8 determines based on a user's predetermined operation of the operation input unit 2 whether a termination instruction to terminate the image generation process is inputted (step S5).

Herein, if it is determined that the termination instruction is inputted (YES in step S5), the image recording unit 5 records the image data of the composite image P3 generated by the image compositing section 4c in the recording medium M (step S6) and then terminates the image generation process.

On the other hand, if it is determined that the termination instruction is not inputted (NO in step S5), the composite image generation unit 4 determines whether the predetermined region A of the composite image P3 is already specified by the region specifying section 4d (step S7).

Herein, if it is determined that the predetermined region A of the composite image P3 is not yet specified (NO in the step S7), the region specifying section 4d determines based on a user's predetermined operation of the operation input unit 2 whether the instruction to specify the predetermined region A of the composite image P3 is inputted (step S8). To be specific, the region specifying section 4d determines based on the touch position detected by the touch panel 2a according to a user's predetermined touch operation of the touch panel 2a whether the instruction to specify the predetermined region A of the composite image P3 (for example, the face region A1) is inputted.

If it is determined in the step S8 that the instruction to specify the predetermined region A is not inputted (NO in the step S8), the region specifying section 4d returns the process to the step S4, and the display controller 1b causes the display screen of the display panel 1a to display the image data of the composite image P3 (the composite image P3a, for example) (step S4).

On the other hand, if it is determined in the step S8 that the instruction to specify the predetermined region A is inputted (YES in the step S8), the composition ratio controller 4e determines based on a user's predetermined operation of the operation input unit 2 whether an instruction to change the transparency of the predetermined region A of the composite image P3 is inputted (step S9).

To be specific, the composition ratio controller 4e determines whether the instruction to change the transparency of the predetermined region A of the composite image P3 is inputted according to the input state of the position signal concerning the touch position outputted from the operation input unit 2 based on a user's predetermined touch operation of the touch panel 2a, that is, the type of the user's touch operation of the touch panel 2a. For example, the composition ratio controller 4e determines that the instruction to change the transparency of the predetermined region A is inputted when the predetermined portion of the touch panel 2a (for example, a portion of the specified composite image P3 where the predetermined region A is displayed) is touched by the user in the predetermined direction and position signals concerning the touch positions are sequentially inputted due to the user's operation.

If it is determined in the step S9 that the instruction to change the transparency of the predetermined region A is not inputted (NO in the step S9), the composite image generation unit 4 returns the process to the step S4, and the display controller 1b causes the display screen of the display panel 1a to display the image data of the composite image P3 (the composite image P3a, for example; see FIG. 3B).

On the other hand, if it is determined in the step S9 that the instruction to change the transparency of the predetermined region A is inputted (YES in the step S9), the composite image generation unit 4 causes the process to branch according to the type of the user's operation of the operation input unit 2 (the user's touch operation of the touch panel 2a, for example) (step S10). To be specific, if the user's operation of the operation input unit 2 is the operation to increase the transparency of the second image P2 (the operation to increase the transparency in the step S10), the composite image generation unit 4 moves the process to step S111. If the user's operation of the operation input unit 2 is the operation to reduce the transparency of the second image P2 (the operation to reduce the transparency in the step S10), the composite image generation unit 4 moves the process to step S121.

### <Case of Increasing Transparency of Second Image P2>

In the step S9, if the portion of the touch panel 2a where the specified predetermined region A is displayed is subjected to the downward touch operation to sequentially supply plural position signals constituting a trajectory extending downward, the composition ratio controller 4e identifies the user's operation as the operation to increase the transparency of the second image P2 (the operation to increase the transparency in the step S10) and then increases the transparency of the second image P2 (the processed image Pb) in the predetermined region A of the composite image P3 at a predetermined rate (by 5%, for example) (step S111). The image compositing section 4c generates the composite image P3 according to the new transparency of the second image P2 changed by the composition ratio controller 4e (the composition ratio of the first image P1 to the second image P2).

Accordingly, if the transparency of the second image P2 in the predetermined region A is 5%, for example, the alpha value of the second image P2 is α=0.05 (0<α<1) (see FIG. 4A), the pixel value of each pixel in the predetermined region A of the composite image P3b is set to a sum (blending) of a product of the pixel value of the corresponding pixel of the first image P1 (the predetermined image Pa) and the alpha value (α=0.05) and a product of the pixel value of the corresponding pixel of the second image P2 (the processed image Pb) and the 1's complement (1−α) (see FIG. 4B).

Next, the composition ratio controller 4e determines whether or not the changed transparency of the second image P2 is 100% or more (step S112).

Herein, if it is determined that the new transparency of the second image P2 is not 100% or more (NO in the step S112), the composition ratio controller 4e returns the process to the step S4. The display controller 1b then acquires the image data of the generated composite image P3 (the composite image P3b, for example) and causes the display screen of the display panel la to display the same (step S4).

Thereafter, the processing of the step S4 and after is executed. To be specific, if it is determined in the step S7 that the predetermined region A of the composite image P3 is already specified (YES in the step S7), the process of the step S8 is skipped. In step S9, the composition ratio controller 4e then determines whether the instruction to change the transparency of the predetermined region A of the composite image P3 is inputted (the step S9).

In the step S10, each time the user performs the operation to increase the transparency of the second image P2 (the operation to increase the transparency in the step S10), the composition ratio controller 4e increases the transparency of the second image P2 (the processed image Pb) in the predetermined region A of the composite image P3 at a predetermined rate (by 5%, for example) (the step S111).

On the other hand, it is determined in step S112 that the changed transparency of the second image P2 is 100% or more (YES in the step S112), the composition ratio controller 4e sets the transparency of the second image P2 to 100% (step S113). The image synthetic section 4c then generates the composite image P3 according to the transparency of the second image P2 changed by the composition ratio controller 4e (the composition ratio of the first image P1 to the second image P2).

Accordingly, if the transparency of the second image P2 in the predetermined region A is 100%, for example, the alpha value of each pixel of the second image P2 is equal to 1 (see FIG. 5A), and each pixel of the predetermined region A of the composite image P3c has the same pixel value as the corresponding pixel of the first image P1 (the predetermined image Pa) (see FIG. 5B).

The composite image generation unit 4 then returns the process to the step S4. The display controller 1b acquires the image data of the generated composite image P3 (for example, the composite image P3c) and causes the display screen of the display panel 1a to display the same (step S4).

Moreover, if the user determines that the predetermined region A of the composite image P3 displayed in the step 4 has an appearance desired by the user and performs a predetermined operation of the operation input unit 2 to instruct termination of the image generation process, the CPU of the central controller 8 determines in the step S5 that the termination instruction to terminate the image generation process is inputted (YES in the step S5). In the step S5, the image recording unit 5 then records the image data of the composite image P3 in the recording medium M and then terminates the image generation process.

### <Case of Reducing Transparency of Second Image P2>

In the step S9, if the portion of the touch panel 2a where the specified predetermined region A is displayed is subjected to the upward touch operation to sequentially supply plural position signals constituting a trajectory extending upward, the composition ratio controller 4e identifies the user's operation as the operation to reduce the transparency of the second image P2 (the operation to increase the transparency in the step S10) and then reduces the transparency of the second image P2 (the processed image Pb) in the predetermined region A of the composite image P3 at a predetermined rate (by 5%, for example) (step S121). The image compositing section 4c generates the composite image P3 (the composite image P3b, for example) according to the new transparency of the second image P2 changed by the composition ratio controller 4e (the composition ratio of the first image P1 to the second image P2).

The method of generating the composite image P3 is the same as that in the case of increasing the transparency of the second image P2, and the detailed description thereof is omitted.

Next, the composition ratio controller 4e determines whether or not the changed transparency of the second mage P2 is 0% or less (step S122).

Herein, if it is determined that the changed transparency of the second image P2 is not 0% or less (NO, in the step S122), the composition ratio controller 4e returns the process to the step S4. The display controller 1b then acquires the image data of the generated composite image P3 (the composite image P3b, for example) and causes the display screen of the display panel la to display the same (step S4).

Thereafter, the processing of the step S4 and after is executed. To be specific, each time the user performs the operation to reduce the transparency of the second image P2 (the operation to reduce the transparency in the step S10), the composition ratio controller 4e reduces the transparency of the second image P2 (the processed image Pb) in the predetermined region A of the composite image P3 at a predetermined rate (by 5%, for example) (step S121).

On the other hand, it is determined in step S122 that the changed transparency of the second image P2 is 0% or less (YES in the step S122), the composition ratio controller 4e sets the transparency of the second image P2 to 0% (step S123). The image synthetic section 4c then generates the composite image P3 according to the new transparency of the second image P2 changed by the composition ratio controller 4e (the composition ratio of the first image P1 to the second image P2).

Accordingly, if the transparency of the second image P2 in the predetermined region A is 0%, for example, the alpha value of each pixel of the second image P2 is equal to α=0 (see FIG. 3A), and each pixel of the predetermined region A of the composite image P3a has the same pixel value as the corresponding pixel of the second image P2 (the processed image Pb) (see FIG. 3B). The pixel value of each pixel of the composite image P3a is set to the pixel value of the corresponding pixel of the second image P2.

The composite image generation unit 4 then returns the process to the step S4. The display controller 1b acquires the image data of the generated composite image P3 (for example, the composite image P3a) and causes the display screen of the display panel 1a to display the same (step S4).

Moreover, if it is determined by the user that the predetermined region A of the composite image P3 displayed in the step 4 has an appearance desired by the user and a predetermined operation of the operation input unit 2 is performed to instruct termination of the image generation process, the CPU of the central controller 8 determines in the step S5 that the termination instruction to terminate the image generation process is inputted (YES in the step S5). In the step S5, the image recording unit 5 then records the image data of the composite image P3 in the recording medium M and then terminates the image generation process.

As described above, according to the image output apparatus 100 of this embodiment, the first image P1, that is, the predetermined image Pa or a processed image obtained by performing a predetermined type of image processing for the predetermined image Pa, and the second image P2, that is, another processed image Pb obtained by performing a different predetermined type of image processing from the type of the image processing concerning the first image P1, are superimposed on each other to generate the composite image P3, and the composition ratio of the first image P1 to second image P2 in the predetermined region A of the composite image P3 which is specified based on a user's predetermined operation of the operation input unit 2 is changed. Accordingly, it is possible to obtain an image of an appearance desired by the user without the need to repeatedly perform image processing for one image with the processing degree of the image processing successively changed based on a user's predetermined operation of the operation input unit 2.

Specifically, it takes a lot of time for an image output apparatus including an arithmetic device not having a high processing capacity to execute image processing even only once. Moreover, it takes longer time to provide an image having an appearance desired by the user if the number of times that image processing is repeated with the processing degree being fine-tuned. On the other hand, the image output device 100 of this embodiment does not repeat image processing with varying processing degree and changes the composition ratio of the first image P1 to the second image P2 in the predetermined region A of the composite image P3. Thus, it seems as if the image output device 100 perform image processing with the processing degree varied in real time. However, the image processing is not performed actually, and the time spent to obtain an image of an appearance desired by the user can be shortened. The composition ratio of the first image P1 to the second image P2 in the predetermined region A of the composite image P3 can be changed by only changing the transparency of the predetermined region A of the upper image of the first and second images P1 and P2 which are superimposed on each other. It is therefore possible to generate an image with the changed composition ratio at high speed without using an arithmetic unit with a high processing capacity.

Accordingly, the process to generate the composite image P3 with the output style of the predetermined region A changed can be performed at higher speed. Moreover, even if the output style of only the predetermine region A in the processing object image is changed, it is possible to reduce the stress on the user due to long time spent by the processing.

The predetermined region A of the composite image P3 is specified based on the touch position detected by the touch panel 2a according to a user's touch operation of the touch panel 2a. Accordingly, the predetermined region A of the composite image P3 can be easily specified by a predetermined operation performed for the touch panel 2a by the user. In other words, the predetermined region A can be easily specified based on a user's intuitive operation of the touch panel 2a.

Furthermore, the transparency of the upper image (the processed image Pb) in the predetermined region A can be changed based on the type of the user's touch operation of the region of the touch panel 2a where the predetermined region A specified is displayed. Accordingly, the user's intuitive operation of the touch panel 2a can be related to change in transparency of the upper image in the predetermine region A, and the transparency of the upper image in the predetermined region A can be changed with an easier operation.

Moreover, the composite image P3 with the changed composition ratio of the first image P1 to the second image P2 is recorded in the recording medium M. Accordingly, the composite image P3 can be effectively used in other processes such as processes to display or print the composite image P3.

The present invention is not limited to the aforementioned embodiment, and various improvements and modification of the design can be made without departing from the spirit of the invention.

For example, in the image generation process of the aforementioned embodiment, it can be configured to generate the composite image P3 including the image data of the predetermined image Pa placed on the upper side and the image data of the processed image Pb placed on the lower side which are superimposed one on the other, that is, the composite image P3 not looking image-processed and gradually perform image processing by changing the transparency of the predetermined region A.

Moreover, it can be configured to place a color image on the lower side while placing an image obtained by binarizing the color image on the upper side and cause the color image to gradually appear by changing the transparency of the predetermined region A.

In the aforementioned embodiment, the transparency of the upper image (the processed image Pb) in the predetermined region A is changed based on the type of the user's touch operation of the predetermined region A of the composite image P3 displayed on the touch panel 2a. The way of changing the transparency is not limited to this example. The transparency can be changed based on the type of the user's touch operation of a predetermined position (a right or left edge portion, for example) of the touch panel 2a.

In the image generation process of this embodiment, the composite image P3 in which the composition ratio of the first image P1 to the second image P2 is changed is recorded in the recording medium M. However, the printing unit 6 may make a print of the composite image P3. This can easily provide the print of the composite image P3 with the composition ratio of the first image P1 to the second image P2 changed.

Furthermore, in the aforementioned embodiment, the image output apparatus 100 does not necessarily include the image recording unit 5 and printing unit 6. The image output apparatus may be provided with any one of the image recording unit 5 and printing unit 6. Moreover, the image output apparatus may be configured to not include any one of the image recording unit 5 and printing unit 6 and output the image data of the generated composite image P3 to an external recording deice or a printer (not shown).

Moreover, in the above embodiment, the operation input unit 2 includes the touch panel 2a. However, it can be properly and arbitrarily changed whether the touch panel 2a is provided, that is, whether the predetermined region A of the composite image P3 is specified based on the touch position detected by the touch panel 2a.

Furthermore, the configuration of the image output apparatus 100 as an image processing apparatus shown in the above embodiment by way of example is just an example, and the image processing apparatus is not limited to this example and can be properly and arbitrarily changed.

In addition, the above embodiment is implemented by the composite image generation unit 4 which is driven under the control of the central controller 8 but not limited to this example. The invention may be implemented by execution of predetermined programs and the like by the CPU of the central controller 8.

Specifically, the program memory configured to store programs stores programs including a first acquisition process routine, a second acquisition process routine, a composition process routine, a specifying process routine, and a control processing routine. The CPU of the central controller 8 may be caused by the first acquisition process routine to acquire the predetermined image Pa as the first image P1. The CPU of the central controller 8 may be caused by the second acquisition process routine to acquire the second image P2 obtained by performing predetermined image processing for the first image P1. Moreover, the CPU of the central controller 8 may be caused by the composition process routine to combine the acquired first image P1 and acquired second image P2 superimposed on each other to generate the composite image P3. The CPU of the central controller 8 may be caused by the specifying process routine to specify the predetermined region A of the composite image P3 based on a user's predetermined operation of the operation input unit 2. The CPU of the central controller 8 may be caused by the control process routine to change the composition ratio of the first image P1 to the second image P2 in the specified predetermined region A by changing the transparency of the upper image of the predetermine region A in the first image P1 and second image P2 superimposed on each other.

Furthermore, a computer-readable medium storing the programs to execute the aforementioned processes can be a ROM, a hard disk, a non-volatile memory such as a flash memory, and a portable recording medium such as a CD ROM. Moreover, the medium providing data of the programs through a predetermined communication line can be a carrier wave.

Some embodiments of the present invention are described above. The scope of the invention is not limited to the aforementioned embodiment and includes a scope of the invention described in claims and equivalents thereof.

The entire disclosure of Japanese Patent Application No. 2011-077381 filed on Mar. 31, 2011 including description, claims, drawings, and abstract are incorporated herein by reference in its entirety.

Although various exemplary embodiments have been shown and described, the invention is not limited to the embodiments shown. Therefore, the scope of the invention is intended to be limited solely by the scope of the claims that follow.

What is claimed is:

1. An image processing apparatus, comprising:
a first acquisition unit to acquire a first image;
a second acquisition unit to acquire a second image obtained by performing predetermined image processing for the first image;
a compositing unit to generate a composite image composed of the first and second images that are combined to be superimposed on each other;
a specifying unit to specify, based on a user's predetermined operation of an operation input unit, a change region in the composite image whose composition ratio is to be changed; and
a controller to change transparency of the upper one of the first and second images to change the composition ratio at which the compositing unit combines the first and second images in the change region specified by the specifying unit.

2. The image processing apparatus according to claim 1, further comprising:
a display unit to display the composite image, wherein
the operation input unit includes a touch panel to detect a touch position at which a display region of the display unit is touched, and
the specifying unit specifies the change region based on the touch position detected by the touch panel according to a user's touch operation of the touch panel.

3. The image processing apparatus according to claim 2,
wherein the controller changes the transparency of the upper image in the change region based on how the user touches a region in the display region where the change region is displayed.

4. The image processing apparatus according to claim 2,
wherein the controller changes the transparency of the upper image in the change region based on how the user touches a predetermined position of the touch panel.

5. The image processing apparatus according to claim 1, further comprising:
a recording unit to record the composite image with the composition ratio of the first image to the second image changed by the controller.

6. The image processing apparatus according to claim 1, further comprising:
a printing unit to print the composite image with the composition ratio of the first image to the second image changed by the controller.

7. An image processing method, comprising the steps of:
acquiring a first image;
acquiring a second image obtained by performing image processing for the first image;
generating a composite image composed of the first and second images that are combined to be superimposed on each other;
specifying a change region in the composite image whose composition ratio is to be changed based on a user's predetermined operation of an operation input unit; and
changing transparency of the upper one of the first and second images to change the specified composition ratio of the first image to second image in the specified change region.

8. A recording medium recording a program for causing a computer of an image processing apparatus to function as:
a first acquisition unit to acquire a first image;
a second acquisition unit to acquire a second image obtained by performing predetermined image processing for the first image;
a compositing unit to generate a composite image composed of the first and second images that are combined to be superimposed on each other;
a specifying unit to specify, based on a user's predetermined operation of an operation input unit, a change region in the composite image whose composition ratio is to be changed; and
a controller to change transparency of the upper one of the first and second images to change the composition ratio at which the compositing unit combines the first and second images in the change region specified by the specifying unit.
